(19) United States
(12) Patent Application Publication
(10) Pub. No.: US 2025/0218446 A1
(43) Pub. Date: Jul. 3, 2025

(54) Spatial Rendering of Reverberation

(71) Applicant: Nokia Technologies Oy, Espoo (FI)

(72) Inventors: Antti Johannes Eronen, Tampere (FI); Sujeet Shyamsundar MATE, Tampere (FI); Arto Juhani LEHTINIEMI, Lempaala (FI)

(21) Appl. No.: 18/841,762

(22) PCT Filed: Feb. 10, 2023
(86) PCT No.: PCT/EP2023/053283

§ 371 Date: Aug. 27, 2024

(30) Foreign Application Priority Data
Mar. 2, 2022 (GB) 2202892.2

(51) Int. Cl. G10L 19/008; G10L 19/002; G10L 19/02

(52) U.S. Cl. CPC G10L 19/008; G10L 19/002; G10L 19/0204

(57) ABSTRACT

An apparatus for assisting spatial rendering in at least one acoustic environment, the apparatus including circuitry configured to: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream including: an identifier identifying the at least one acoustic environment; information defining at least one dimension of the at least one acoustic environment; and a reverberation parameter part comprising including a selection, based on the comparison, of one or more of: the encoded at least one frequency band data; and the encoded at least one reverberation parameter.

### FIELD

The present application relates to apparatus and methods for generating and employment of spatial rendering of reverberation, but not exclusively for spatial rendering of reverberation in augmented reality and/or virtual reality apparatus.

### BACKGROUND

Reverberation refers to the persistence of sound in a space after the actual sound source has stopped. Different spaces are characterized by different reverberation characteristics. For conveying spatial impression of an environment, reproducing reverberation perceptually accurately is important. Room acoustics are often modelled with individually synthesized early reflection portion and a statistical model for the diffuse late reverberation. FIG. 1 depicts an example of a synthesized room impulse response where the direct sound 101 is followed by discrete early reflections 103 which have a direction of arrival (DOA) and diffuse late reverberation 105 which can be synthesized without any specific direction of arrival. The delay d1(t) 102 in FIG. 1 can be seen to denote the direct sound arrival delay from the source to the listener and the delay d2(t) 104 can denote the delay from the source to the listener for one of the early reflections (in this case the first arriving reflection).

One method of reproducing reverberation is to utilize a set of N loudspeakers (or virtual loudspeakers reproduced binaurally using a set of head-related transfer functions (HRTF)). The loudspeakers are positioned around the listener somewhat evenly. Mutually incoherent reverberant signals are reproduced from these loudspeakers, producing a perception of surrounding diffuse reverberation.

The reverberation produced by the different loudspeakers has to be mutually incoherent. In a simple case the reverberations can be produced using the different channels of the same reverberator, where the output channels are uncorrelated but otherwise share the same acoustic characteristics such as RT60 time and level (specifically, the diffuse-to-direct ratio or reverberant-to-direct ratio). Such uncorrelated outputs sharing the same acoustic characteristics can be obtained, for example, from the output taps of a Feedback-Delay-Network (FDN) reverberator with suitable tuning of the delay line lengths, or from a reverberator based on using decaying uncorrelated noise sequences by using a different uncorrelated noise sequence in each channel. In this case, the different reverberant signals effectively have the same features, and the reverberation is typically perceived to be similar to all directions.

Reverberation spectrum or level can be controlled using the diffuse-to-direct ratio (DDR), which describes the ratio of the energy (or level) of reverberant sound energy to the direct sound energy (or the total emitted energy of a sound source).

### SUMMARY

There is provided according to a first aspect an apparatus for assisting spatial rendering in at least one acoustic environment, the apparatus comprising means configured to: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

The at least one frequency band data may be organised as octave bands.

The at least one frequency band data may further comprise: an index identifying a centre band frequency range; and a number of bands.

The means configured to generate the bitstream may be configured to generate the bitstream comprising a selection indicator configured to indicate the selection, based on the comparison, of one or more of: the encoded at least one frequency band data; and the encoded at least one reverberation parameter within the bitstream.

The apparatus may be further configured to obtain a scene description defining a virtual scene forming at least part of the at least one acoustic environment, wherein the at least one reverberation parameter may be associated with the virtual scene.

The at least one reverberation parameter may be a frequency dependent reverberation parameter.

The resources may be one of: encoded bitrate; encoded bits; and channel capacity.

The means configured to select, based on the comparison, the one or more of: the encoded at least one frequency band data; and the encoded at least one reverberation parameter may be configured to: select the encoded at least one reverberation parameter in a high bitrate mode; and select the encoded at least one frequency band data in a low bitrate mode.

According to a second aspect there is provided an apparatus for assisting spatial rendering in at least one acoustic environment, the apparatus comprising means configured to: obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decode the reverberation parameter part to generate decoded reverberation parameters; obtain reverberator parameters from the decoded reverberation parameters; initialize at least one reverberator based on the reverberator parameters; obtain at least one input audio signal associated with the at least one acoustic environment; and generate an output audio signal based on the application of the at least one reverberator to the at least one input audio signal.

The bitstream may further comprise at least one indicator indicating that the bitstream comprises at least one of: the encoded at least one frequency band data and the encoded at least one reverberation parameter, wherein the means configured to obtain reverberator parameters from the decoded reverberation parameters may be configured to determine the reverberation parameter part based on the indicator.

The means configured to obtain reverberator parameters from the decoded reverberation parameters may be configured to determine the reverberation parameter part based on the indicator and configured to: determine the bitstream comprises the at least one reverberation parameter in a high bitrate mode; and determine the bitstream comprises the at least one frequency band data in a low bitrate mode.

The means configured to obtain reverberator parameters from the decoded reverberation parameters may be configured to determine the reverberation parameter part further comprises an indicator indicating that the reverberator parameters are to be determined from at least one reverberation parameter encoded into a scene payload.

The means configured to initialize at least one reverberator based on the reverberator parameters may be configured to initialize the at least one reverberator using the at least one reverberator parameter independent on whether at least one acoustic environment is a virtual acoustic environment or an augmented reality acoustic environment.

According to a third aspect there is provided a method for an apparatus for assisting spatial rendering in at least one acoustic environment, the method comprising: obtaining at least one reverberation parameter; converting the obtained at least one reverberation parameter into at least one frequency band data; encoding the at least one frequency band data; encoding the at least one reverberation parameter; comparing resources required to transmit the encoded at least one frequency band data and the encoded at least one reverberation parameter; generating a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

The at least one frequency band data may be organised as octave bands.

The at least one frequency band data may further comprise: an index identifying a centre band frequency range; and a number of bands.

Generating the bitstream may comprise generating the bitstream comprising a selection indicator configured to indicate the selection, based on the comparison, of one or more of: the encoded at least one frequency band data; and the encoded at least one reverberation parameter within the bitstream.

The method may further comprise obtaining a scene description defining a virtual scene forming at least part of the at least one acoustic environment, wherein the at least one reverberation parameter is associated with the virtual scene.

The at least one reverberation parameter may be a frequency dependent reverberation parameter.

The resources may be one of: encoded bitrate; encoded bits; and channel capacity.

Generating the bitstream comprising the reverberation parameter part comprising the selection, based on the comparison, of one or more of: the encoded at least one frequency band data; and the encoded at least one reverberation parameter may comprise: selecting the encoded at least one reverberation parameter in a high bitrate mode; and selecting the encoded at least one frequency band data in a low bitrate mode.

According to a fourth aspect there is provided a method for an apparatus for assisting spatial rendering in at least one acoustic environment, the method comprising: obtaining a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decoding the reverberation parameter part to generate decoded reverberation parameters; obtaining reverberator parameters from the decoded reverberation parameters; initializing at least one reverberator based on the reverberator parameters; obtaining at least one input audio signal associated with the at least one acoustic environment; and generating an output audio signal based on the application of the at least one reverberator to the at least one input audio signal.

The bitstream may further comprise at least one indicator indicating that the bitstream comprises at least one of: the encoded at least one frequency band data and the encoded at least one reverberation parameter, wherein obtaining reverberator parameters from the decoded reverberation parameters may comprise determining the reverberation parameter part based on the indicator.

Obtaining reverberator parameters from the decoded reverberation parameters may comprise determining the reverberation parameter part based on the indicator, wherein determining the reverberation parameter part based on the indicator may comprise: determining the bitstream comprises the at least one reverberation parameter in a high bitrate mode; and determining the bitstream comprises the at least one frequency band data in a low bitrate mode.

Obtaining reverberator parameters from the decoded reverberation parameters may comprise determining the reverberation parameter part comprising an indicator indicating that the reverberator parameters are to be determined from at least one reverberation parameter encoded into a scene payload.

Initializing at least one reverberator based on the reverberator parameters may comprise initializing the at least one reverberator using the at least one reverberator parameter independent on whether at least one acoustic environment is a virtual acoustic environment or an augmented reality acoustic environment.

According to a fifth aspect there is provided an apparatus for assisting spatial rendering in at least one acoustic environment, the apparatus comprising at least one processor and at least one memory including a computer program code, the at least one memory and the computer program code configured to, with the at least one processor, cause the apparatus at least to: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

The at least one frequency band data may be organised as octave bands.

The at least one frequency band data may further comprise: an index identifying a centre band frequency range; and a number of bands.

The apparatus caused to generate the bitstream may be caused to generate the bitstream comprising a selection indicator configured to indicate the selection, based on the comparison, of one or more of: the encoded at least one frequency band data; and the encoded at least one reverberation parameter within the bitstream.

The apparatus may be further caused to obtain a scene description defining a virtual scene forming at least part of the at least one acoustic environment, wherein the at least one reverberation parameter may be associated with the virtual scene.

The at least one reverberation parameter may be a frequency dependent reverberation parameter.

The resources may be one of: encoded bitrate; encoded bits; and channel capacity.

The apparatus caused to select, based on the comparison, the one or more of: the encoded at least one frequency band data; and the encoded at least one reverberation parameter may be caused to: select the encoded at least one reverberation parameter in a high bitrate mode; and select the encoded at least one frequency band data in a low bitrate mode.

According to a sixth aspect there is provided an apparatus for assisting spatial rendering in at least one acoustic environment, the apparatus comprising at least one processor and at least one memory including a computer program code, the at least one memory and the computer program code configured to, with the at least one processor, cause the apparatus at least to: obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decode the reverberation parameter part to generate decoded reverberation parameters; obtain reverberator parameters from the decoded reverberation parameters; initialize at least one reverberator based on the reverberator parameters; obtain at least one input audio signal associated with the at least one acoustic environment; and generate an output audio signal based on the application of the at least one reverberator to the at least one input audio signal.

The bitstream may further comprise at least one indicator indicating that the bitstream comprises at least one of: the encoded at least one frequency band data and the encoded at least one reverberation parameter, wherein the apparatus caused to obtain reverberator parameters from the decoded reverberation parameters may be caused to determine the reverberation parameter part based on the indicator.

The apparatus caused to obtain reverberator parameters from the decoded reverberation parameters may be caused to determine the reverberation parameter part based on the indicator and caused to: determine the bitstream comprises the at least one reverberation parameter in a high bitrate mode; and determine the bitstream comprises the at least one frequency band data in a low bitrate mode.

The apparatus caused to obtain reverberator parameters from the decoded reverberation parameters may be caused to determine the reverberation parameter part further comprises an indicator indicating that the reverberator parameters are to be determined from at least one reverberation parameter encoded into a scene payload.

The apparatus caused to initialize at least one reverberator based on the reverberator parameters may be caused to initialize the at least one reverberator using the at least one reverberator parameter independent on whether at least one acoustic environment is a virtual acoustic environment or an augmented reality acoustic environment.

According to a seventh aspect there is provided an apparatus for assisting spatial rendering in at least one acoustic environment, the apparatus comprising: obtaining circuitry configured to obtain at least one reverberation parameter; converting circuitry configured to convert the obtained at least one reverberation parameter into at least one frequency band data; encoding circuitry configured to encode the at least one frequency band data; encoding circuitry configured to encode the at least one reverberation parameter; comparing circuitry configured to compare resources required to transmit the encoded at least one frequency band data and the encoded at least one reverberation parameter; generating circuitry configured to generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

According to an eighth aspect there is provided an apparatus for assisting spatial rendering in at least one acoustic environment, the apparatus comprising: obtaining circuitry configured to obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decoding circuitry configured to decode the reverberation parameter part to generate decoded reverberation parameters; obtaining circuitry configured to obtain reverberator parameters from the decoded reverberation parameters; initializing circuitry configured to initialize at least one reverberator based on the reverberator parameters; obtaining circuitry configured to obtain at least one input audio signal associated with the at least one acoustic environment; and generating circuitry configured to generate an output audio signal based on the application of the at least one reverberator to the at least one input audio signal.

According to a ninth aspect there is provided a computer program comprising instructions [or a computer readable medium comprising program instructions] for causing an apparatus, for assisting spatial rendering in at least one acoustic environment, to perform at least the following: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

According to a tenth aspect there is provided a computer program comprising instructions [or a computer readable medium comprising program instructions] for causing an apparatus, for assisting spatial rendering in at least one acoustic environment, to perform at least the following: obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decode the reverberation parameter part to generate decoded reverberation parameters; obtain reverberator parameters from the decoded reverberation parameters; initialize at least one reverberator based on the reverberator parameters; obtain at least one input audio signal associated with the at least one acoustic environment; and generate an output audio signal based on the application of the at least one reverberator to the at least one input audio signal.

According to an eleventh aspect there is provided a non-transitory computer readable medium comprising program instructions for causing an apparatus, for assisting spatial rendering in at least one acoustic environment, to perform at least the following: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

According to a twelfth aspect there is provided a non-transitory computer readable medium comprising program instructions for causing an apparatus, for assisting spatial rendering in at least one acoustic environment, to perform at least the following: obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decode the reverberation parameter part to generate decoded reverberation parameters; obtain reverberator parameters from the decoded reverberation parameters; initialize at least one reverberator based on the reverberator parameters; obtain at least one input audio signal associated with the at least one acoustic environment; and generate an output audio signal based on the application of the at least one reverberator to the at least one input audio signal.

According to a thirteenth aspect there is provided an apparatus, for assisting spatial rendering in at least one acoustic environment, comprising: means for obtaining at least one reverberation parameter; means for converting the obtained at least one reverberation parameter into at least one frequency band data; means for encoding the at least one frequency band data; means for encoding the at least one reverberation parameter; means for comparing resources required to transmit the encoded at least one frequency band data and the encoded at least one reverberation parameter; means for generating a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

According to a fourteenth aspect there is provided an apparatus, for assisting spatial rendering in at least one acoustic environment, comprising: means for obtaining a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; means for decoding the reverberation parameter part to generate decoded reverberation parameters; means for obtaining reverberator parameters from the decoded reverberation parameters; means for initializing at least one reverberator based on the reverberator parameters; means for obtaining at least one input audio signal associated with the at least one acoustic environment; and means for generating an output audio signal based on the application of the at least one reverberator to the at least one input audio signal.

According to a fifteenth aspect there is provided a computer readable medium comprising program instructions for causing an apparatus, for assisting spatial rendering in at least one acoustic environment, to perform at least the following: obtain at least one reverberation parameter; convert the obtained at least one reverberation parameter into at least one frequency band data; encode the at least one frequency band data; encode the at least one reverberation parameter; compare resources required to transmit the encoded at least one frequency band data and the encoded at least one reverberation parameter; generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; and the encoded at least one reverberation parameter.

According to a sixteenth aspect there is provided a computer readable medium comprising program instructions for causing an apparatus, for assisting spatial rendering in at least one acoustic environment, to perform at least the following: obtain a bitstream, the bitstream comprising: an identifier identifying the at least one acoustic environment; information defining at least one dimension of the at least one acoustic environment; and a reverberation parameter part comprising one of: an encoded at least one frequency band data and an encoded at least one reverberation parameter; decode the reverberation parameter part to generate decoded reverberation parameters; obtain reverberator parameters from the decoded reverberation parameters; initialize at least one reverberator based on the reverberator parameters; obtain at least one input audio signal associated with the at least one acoustic environment; and generate an output audio signal based on the application of the at least one reverberator to the at least one input audio signal.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows a model of room acoustics and the room impulse response;

FIG. 2 shows an example environment within which embodiments can be implemented showing an audio scene with an audio portal or acoustic coupling;

FIG. 3 shows schematically an example apparatus within which some embodiments may be implemented;

FIG. 4 shows a flow diagram of the operation of the example apparatus as shown in FIG. 3;

FIG. 5 shows schematically an example reverberator controller as shown in FIG. 3 according to some embodiments;

FIG. 6 shows a flow diagram of the operation of the example reverberator controller as shown in FIG. 5;

FIG. 7 shows schematically an example reverberator output signals spatialization controller as shown in FIG. 3 according to some embodiments;

FIG. 8 shows a flow diagram of the operation of the example reverberator output signals spatialization controller as shown in FIG. 7;

FIG. 9 shows schematically an example reverberator output signals spatializer as shown in FIG. 3 according to some embodiments;

FIG. 10 shows a flow diagram of the operation of the example Reverberator output signals spatializer as shown in FIG. 9;

FIG. 11 shows schematically an example FDN reverberator as shown in FIG. 3 according to some embodiments;

FIG. 12 shows schematically an example bitstream generator according to some embodiments;

FIG. 13 shows a flow diagram of the operation of the example feedback filter designer as shown in FIG. 12;

FIG. 14 shows schematically an example apparatus with transmission and/or storage within which some embodiments can be implemented; and

FIG. 15 shows an example device suitable for implementing the apparatus shown in previous figures.

### EMBODIMENTS OF THE APPLICATION

The following describes in further detail suitable apparatus and possible mechanisms for parameterizing and rendering audio scenes with reverberation. Thus for example the suitable apparatus and methods can be part of a spatial audio rendering (also known as spatial rendering).

As discussed above reverberation can be rendered using, e.g., a Feedback-Delay-Network (FDN) reverberator with a suitable tuning of delay line lengths. An FDN allows to control the reverberation times (RT60) and the energies of different frequency bands individually. Thus, it can be used to render the reverberation based on the characteristics of the room or modelled space. The reverberation times and the energies of the different frequencies are affected by the frequency-dependent absorption characteristics of the room.

As described above the reverberation spectrum or level can be controlled using a diffuse-to-direct ratio, which describes the ratio of the energy (or level) of reverberant sound energy to the direct sound energy (or the total emitted energy of a sound source). In ISO/IEC JTC1/SC29/WG6 N00054 MPEG-I Immersive Audio Encoder Input Format, the input to the encoder is provided as DDR value which indicates the ratio of the diffuse (reverberant) sound energy to the total emitted energy of a sound source. Another well-known measure is the RDR which refers to reverberant-to-direct ratio and which can be measured from an impulse response. The relation between these two, described in ISO/IEC JTC1/SC29/WG6 N0083 MPEG-I Immersive Audio CfP Supplemental Information, Recommendations and Clarifications, Version 1, is that

10*log 10(DDR)=10*log 10(RDR)−41 dB.

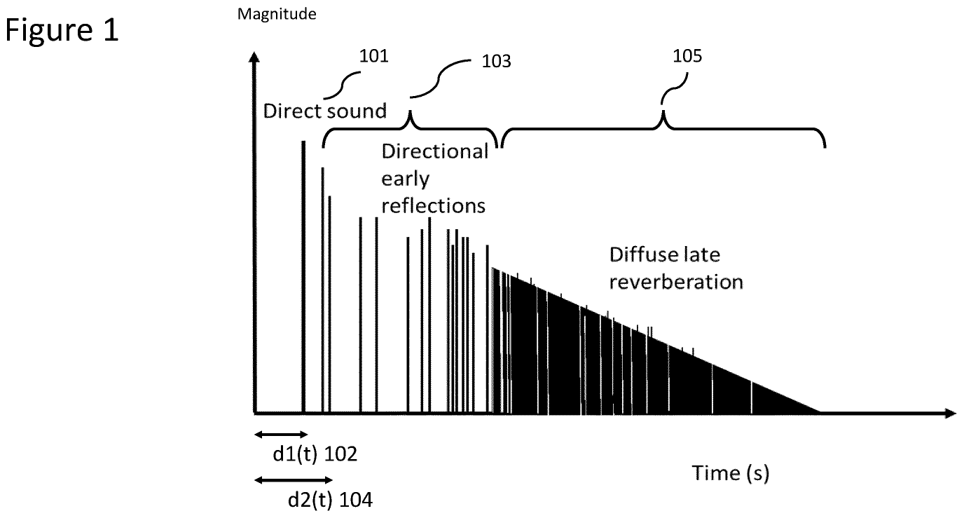

Referring to FIG. 1, the RDR can be calculated by
summing the squares of the sample values of the diffuse late reverberation portion 105
summing the squares of the sample values of the direct sound portion 101
calculating the ratio of these two sums to give the RDR.

The logarithmic RDR can be obtained as 10*log 10(RDR).

In a virtual environment for virtual reality (VR) or a real physical environment for augmented reality (AR) there can be several acoustic environments, each with their own reverberation parameters which can be different in different acoustic environments.

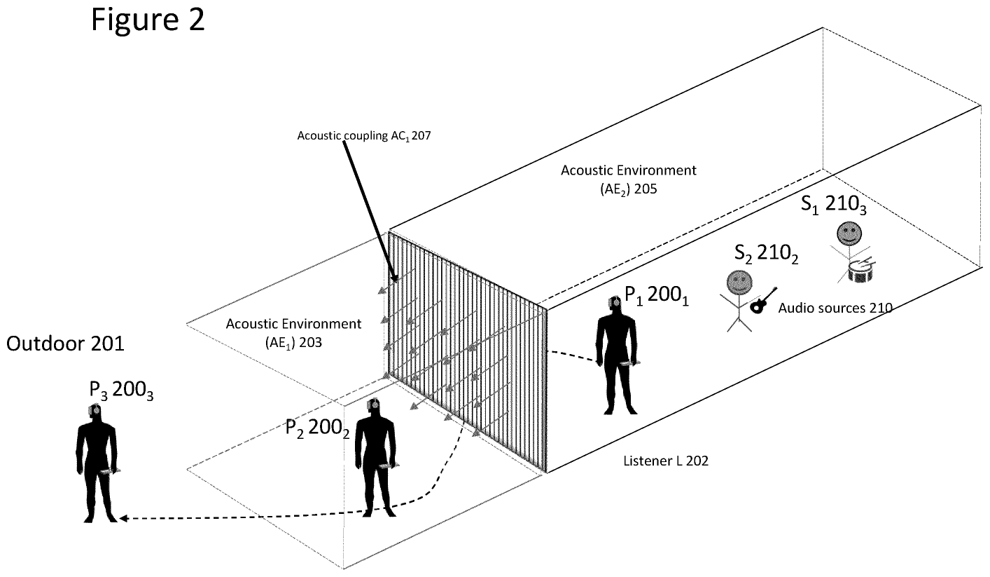

An example of such an environment is shown in FIG. 2. In this example there is shown the audio scene comprising a first acoustic environment AE₁ 203, a second acoustic environment AE₂ 205 and outdoor 201. There is shown an acoustic coupling AC₁ 207 between the first acoustic environment AE₁ 203 and a second acoustic environment AE₂ 205.

In this example the sound or audio sources 210 are located within the second acoustic environment AE₂ 205. In this example the audio sources 210 comprise a first audio source, a drummer, S₁ 210₃ and a second audio source, a guitarist, S₂ 210₂. The Listener 202 is further shown moving through the audio scene and is shown in the first acoustic environment AE₁ 203 at position P₁ 200₁, in the second acoustic environment AE₂ 205 at position P₂ 200₂ and outdoor 201 at position P₃ 200₃.

There are known methods where the encoder converts reverberation parameters of the acoustic environment into reverberator parameters for the FDN reverberator and then creates a bitstream of the optimized reverberator parameters. While the benefit of this approach is that encoder optimization can be used to provide optimal reverberator parameters based on the reverberation characteristics of the virtual environment, the disadvantage is that the bitstream size is not as small as possible.

Furthermore there are known methods where high-perceptual-quality reverberation can be synthesized for physical environments in augmented reality, if reverberation parameters are obtained only at the renderer. However, these methods currently lack the possibility of obtaining reverberation parameters from the bitstream.

For some usage scenarios, such as ones where content is streamed or downloaded over the air and especially where the end user device is moving such as a mobile phone or a vehicle, it is desirable for the bitrate required for 6DoF reverberation rendering (or spatial rendering) for virtual environments to be as small as possible. This is to ensure fast content download speed, uninterrupted streaming, and/or fast playback startup.

Therefore, there is a need for apparatus and methods which can utilize a compact bitstream for reverberation parameters while still producing high quality reverberation. If the reverberation parameter bitstream is not compact, there can be usage scenarios which produce poor user experience because of slow download speed, interrupted streaming, and/or slow playback startup. If reverberation is not high enough quality then a poor user experience, because of suboptimal audio quality and poor immersion, can occur.

Control of activating/prioritizing reverberators is described in GB2200043.4, which specifically discusses a mechanism of prioritizing reverberators and activating only a subset of them based on the prioritization. GB2200335.4 furthermore describes a method to adjust reverberation level especially in augmented reality (AR) rendering. WO2021186107 describes late reverb modelling from acoustic environment information using FDNs and specifically describes designing a DDR filter to adjust the late reverb level based on input DDR data. GB2020673.6 describes a method and apparatus for fusion of virtual scene description in bitstream and listener space description for 6DoF rendering and specifically for late reverberation modelling for immersive audio scenes where the acoustic environment is a combination of content creator specified virtual scene as well as listener-consumption-space influenced listening space parameters. Thus, this background describes a method for rendering in AR audio scene comprising virtual scene description acoustic parameters and real-world listening-space acoustic parameters. GB2101657.1 describes late reverb rendering filter parameters are derived for a low latency renderer application. GB2116093.2 discusses reproduction of diffuse reverberation where a method is proposed that enables the reproduction of rotatable diffuse reverberation where the characteristics of the reverberation may be directionally dependent (i.e., having different reverberation characteristics in different directions) using a number of processing paths (at least 3, typically 6-20 paths) (virtual) multichannel signals by determining at least two panning gains based on a target direction and the positions of the (virtual) loudspeakers in a (virtual) loudspeaker set (e.g., using VBAP), obtaining mutually incoherent reverberant signals for each of the determined gains (e.g., using outputs of two reverberators tuned to produce mutually incoherent outputs, or using decorrelators), applying the determined gains for the corresponding obtained reverberant signals in order to obtain reverberant multichannel signals, combining the reverberant multichannel signals from the different processing paths, and reproducing the combined reverberant multichannel signals from the corresponding (virtual) loudspeakers. GB2115533.8 discusses a method for seamless listener transition between acoustic environments.

The concept as discussed in the embodiments herein relates to reproduction of late reverberation in 6DoF audio rendering systems based on acoustic scene reverberation parameters where the solution is configured to transmit compact reverberation parameters and to convert them to reverberator parameters in a renderer to achieve low reverberation parameter bitstream size for low storage and network bandwidth requirements while still maintaining spatial rendering with high perceptual quality to achieve an immersive audio experience.

Thus in some embodiments the apparatus and methods relate to reproduction of late reverberation in 6DoF audio rendering systems based on acoustic scene reverberation parameters where the solution is configured to transmit compact reverberation parameters and to convert them to reverberator parameters in a renderer to achieve low reverberation parameter bitstream size suitable for low storage requirements and low network bandwidth requirements while still maintaining spatial rendering with high perceptual quality to achieve an immersive audio experience.

This can be achieved by apparatus and methods configured to implement the following operations (within an encoder):
obtain frequency-dependent reverberation parameters associated with a virtual acoustic environment;
convert the frequency-dependent reverberation parameters to frequency band data;
encode the frequency band data into encoded frequency band data;
encode the frequency-dependent reverberation parameters into encoded reverberation parameters;
compare the bitrate required to transmit 1) the encoded frequency band data or 2) the encoded reverberation parameters;
encode into bitstream compact reverberation parameters which are either 1) the encoded frequency band data or 2) the encoded reverberation parameters based on the comparison and associate them with the acoustic environment identifier and its dimensions.

In the following examples the frequency bands are shown as octave bands. In some embodiments the division of frequency bands can be any suitable division. For example there could also be several such known, alternative frequency band divisions, identified based on the number of values. Such an example can be spacing for 4, 6, 8, and 10 frequency bands. In some embodiments there is a dictionary of known frequency band centre frequencies and number of bands, and, instead of transmitting the centre frequencies the method is configured to send the index of the known centre band & number of bands combination.

Furthermore in some embodiments there is described apparatus and methods configured to implement the following operations (within a renderer):
obtain from a bitstream the compact reverberation parameters which are either encoded frequency band data or encoded reverberation parameters, an identifier and dimensions of an acoustic environment;
decode the received compact reverberation parameters;
convert the decoded compact reverberation parameters into reverberator parameters;
Initialize a reverberator to render reverberation using the reverberator parameters; and
receive at least one input signal associated with the virtual acoustic environment and render an immersive output audio signal using the reverberator.

In some embodiments the parameters are encoded into a reverberation bitstream payload.

Furthermore in some embodiments the parameters are not explicitly encoded into a reverberation bitstream payload but the reverberation bitstream payload contains a bit implying that reverberation parameters have been encoded into a scene payload.

In some embodiments the initialization of the reverberator using the parameters is implemented in the same manner as when a reverberator is initialized for rendering reverberation for an augmented reality (physical) scene and when reverberation parameters for the augmented reality scene are received directly in the renderer.

Furthermore in some embodiments, the reverberator used for rendering reverberation using the compact reverberation parameters can also be used for rendering reverberation for virtual acoustic environments when reverberator parameters are received in the bitstream.

In some embodiments the apparatus and methods can be configured to encode the compact reverberation parameters into bitstream when operating in a low bitrate mode.

In some embodiments the reverberator used for rendering reverberation using the compact reverberation parameters differs from the reverberator used for rendering reverberation for augmented reality physical scenes or virtual reality scenes when the solution is configured to not operate in a low bitrate mode.

Furthermore in some embodiments an indication in the reverb payload bitstream can be used to indicate to the renderer to use reverberation parameters from the audio scene description in the bitstream.

In some embodiments, the indication in the reverb payload bitstream to utilize reverberation parameters signals the expectation to perform reverberation auralization during rendering.

It is understood that ISO/IEC 23090-4 MPEG-I Audio Phase 2 will normatively standardize the bitstream and the renderer processing. There will also be an encoder reference implementation, but it can be modified later on as long as the output bitstream follows the normative spec. This allows improving the codec quality also after the standard has been finalized with novel encoder implementations.

With respect to the embodiments described herein, the portions going to different parts of the MPEG-I standard are as follows:
the normative bitstream can contain encoded octave band data or encoded frequency-dependent reverberation data for each acoustic environment. The encoded frequency-dependent reverberation data can be under the reverb payload or under the scene payload; and
the normative renderer can decode the bitstream to obtain scene and compact reverberation parameters, decode and map these to reverberator parameters, and render reverberated signal using the reverberator.

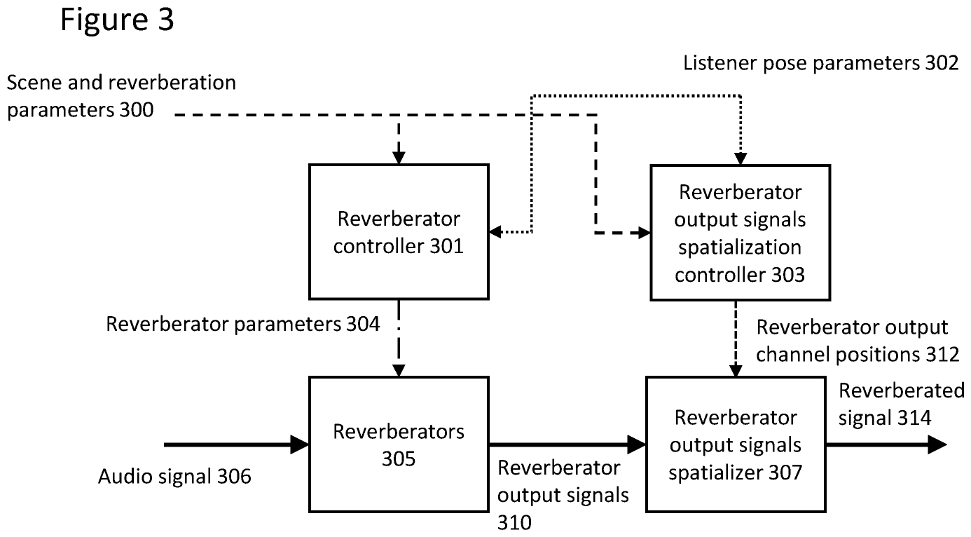

With respect to FIG. 3 is shown an example system of apparatus suitable for implementing some embodiments. The apparatus can in some embodiments be part of a spatial rendering system as described later on.

The input to the system of apparatus is scene and reverberator parameters 300, listener pose parameters 302 and audio signal 306. The system of apparatus generates as an output, a reverberated signal 314 (e.g. binauralized with head-related-transfer-function (HRTF) filtering for reproduction to headphones, or panned with Vector-Base Amplitude Panning (VBAP) for reproduction to loudspeakers).

In some embodiments the apparatus comprises a reverberator controller 301. The reverberator controller 301 is configured to obtain or receive the scene and reverberation parameters 300. In this example implementation the scene and reverberation parameters are in the form of a bitstream which contains enclosing room geometry and parameters describing the RT60 times and reverberant-to-direct ratio (RDR) for the enclosure (or Acoustic Environment).

The reverberator controller 301 is configured to obtain the bitstream, convert the encoded reverberation parameters into parameters for a reverberator (reverberator parameters), and pass the reverberator parameters to initialize at least one FDN reverberator to reproduce reverberation according to the reverberator parameters. The reverberator parameters 304 can then be passed to the reverberator(s) 305.

In some embodiments the apparatus comprises a reverberator or reverberators 305. The reverberator(s) are configured to receive the reverberator parameters 304 and the audio signal sᵢₙ(t) (where t is time) 306. In some embodiments the reverberator(s) 305 are configured to reverberate the audio signal 306 based on the reverberator parameters 304.

The details of the reverberation processing are presented in further detail later.

The reverberators 305 in some embodiments output the resulting reverberator output signals s_{rev,r}(j,t) 310 (where j is the output audio channel index and r the reverberator index). There are several reverberators, each of which produce several output audio signals. These reverberator output signals 310 are input into a reverberator output signals spatializer 307.

Furthermore the apparatus comprises a reverberator output signals spatialization controller 303. The reverberator output signals spatialization controller 303 is configured to receive the scene and reverberation parameters 300 and the listener pose parameters 302 and generate reverberator output channel positions 312. The reverberator output channel positions 312 in some embodiments indicates cartesian coordinates which are to be used when rendering each of the signals in s_{rev,r}(j,t). In some other embodiments other representations (or other co-ordinate system) such as polar coordinates can be used. The output channel positions can be virtual loudspeaker positions (or positions in a space which are unrelated to an actual or physical loudspeaker but can be used to generate a suitable spatial audio signal format such as binaural audio signals), or actual loudspeaker positions (for example in multi-speaker systems such as 5.1, 7.2 channel systems).

In some embodiments the apparatus comprises a reverberator output signals spatializer 307. The reverberator output signals spatializer 307 is configured to obtain the reverberator output signals 310 and the reverberator output channel positions 312 and based on these produces an output signal suitable for reproduction via headphones or via loudspeakers. In some embodiments the reverberator output signals spatializer 307 is configured to render each reverberator output into a desired output format, such as binaural, and then sum the signals to produce the output reverberated signal 314. For binaural reproduction the reverberator output signals spatializer 307 can further use HRTF filtering to render the reverberator output signals 310 in their desired positions indicated by the reverberator output channel positions 312.

This reverberation in the reverberated signals 314 is therefore based on the scene and reverberator parameters 300 as was desired and further considers listener pose parameters 302.

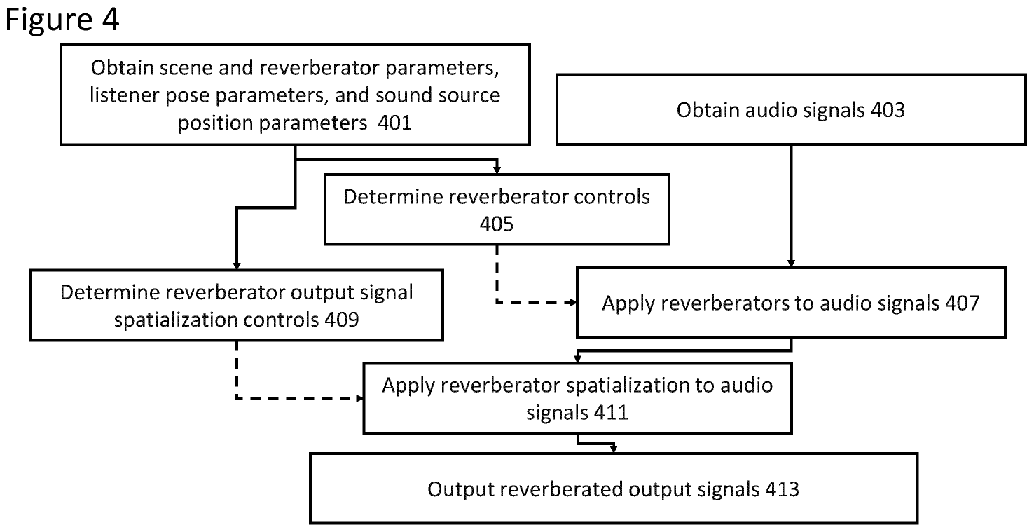

With respect to FIG. 4 is shown a flow diagram showing the operations of example apparatus shown in FIG. 3 according to some embodiments.

Thus, for example, the method may comprise obtaining scene and reverberator parameters and obtaining listener pose parameters is shown in FIG. 4 by step 401.

Furthermore the audio signals are obtained is shown in FIG. 4 by step 403.

Then the reverberator controls are determined based on the obtained scene and reverberator parameters and listener pose parameters is shown in FIG. 4 by step 405.

Then the reverberators controlled by the reverberator controls are applied to the audio signals as shown in FIG. 4 by step 407.

Furthermore the reverberator output signal spatialization controls are determined based on the obtaining scene and reverberator parameters and listener pose parameters as shown in FIG. 4 by step 409.

The reverberator spatialization based on the reverberator output signal spatialization controls can then be applied to the reverberated audio signals from the reverberators to generate output reverberated audio signals as shown in FIG. 4 by step 411.

Then the output reverberated audio signals are output as shown in FIG. 4 by step 413.

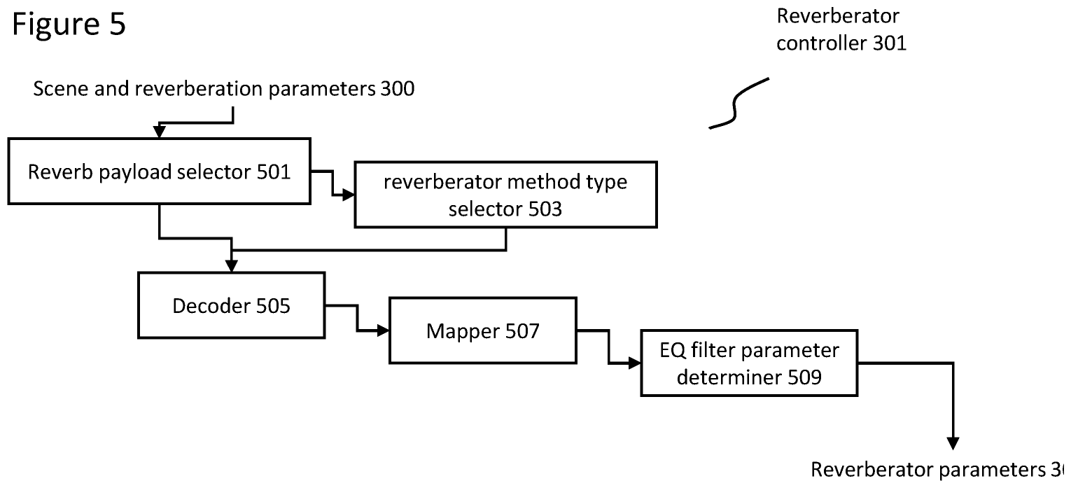

With respect to FIG. 5 there is shown in further detail an example reverberator controller 301. As discussed above the reverberator controller 302 is configured to provide reverberator parameters to the reverberator(s). The reverberation controller 302 is configured to receive encoded reverberation parameters which describe the reverberation characteristics in each acoustic environment (each acoustic environment contains at least one set of reverberation parameters). The reverberation controller can be configured to decode the obtained reverberation parameters and convert the decoded parameters into concrete reverberator parameters. The input to the apparatus can be configured to provide the desired RT60 times per specified frequencies k denoted as RT60(k) and DDR values DDR(k). An alternative representation for the DDR is RDR, or its logarithm log RDR(k). To be useful for reverberation, parameters for a concrete reverberator need to be obtained based on these values, so that the reverberator 305 can then be used for reproducing reverberation.

In some embodiments the reverberator controller 301 comprises a reverberator payload selector 501. The reverberator payload selector 501 is configured to determine how reverberation parameters for acoustic environments are represented. In some embodiments an indicator or flag from the bitstream provides the information to make the selection. Thus, for example, when the bit use_reverb_payload_metadata is not set (equal to 0), the reverberation parameters are encoded in the scene payload and the controller is configured to obtain the reverberation parameters from a scene payload section. In an example embodiment the reverberation parameters are encoded as frequency data when carried in the scene payload.

If use_reverb_payload_metadata is set (equal to 1), the reverberation parameters are encoded either as octave band data (without the octave centre frequencies) or as frequency-dependent data with combinations of frequency-control value.

The payload selector 501 is then configured to control the decoder 505.

Furthermore in some embodiments the reverberator controller 301 comprises a reverberator method type selector 503. The reverberator method type selector 503 is configured to determine the method type for the reverberator. For example the parameters of the reverberator can be adjusted so that they produce reverberation having characteristics matching the desired RT60(k) and DDR(k) for the acoustic environment to which this FDN reverberator is to be associated. For example whether the acoustic environment/scene is a virtual reality (VR) scene or augmented reality (AR) scene.

For example in some embodiments the reverberator method type selector is configured to control the decoding and adjustment of the parameters based on an indicator or flag such that when reverb_method_type==1 the reverberator parameters are obtained directly from the bitstream, and when reverb_method_type==2 or reverb_method_type==3 the reverberator parameters are adjusted or optimized based on the reverberation parameters obtained from the bitstream. In an example embodiment reverb_method_type==1 and reverb_method_type==2 and reverb_method_type==3 are applicable for VR scenes and the processing (optimizing of reverberator parameters) occurring as a result of reverb_method_type==2 and reverb_method_type==3 is similar to when reverberation parameters are obtained for an augmented reality (AR) scene.

In some embodiments the reverberator controller 301 comprises a decoder 505, the decoder 505 is controlled based on the outputs of the reverberator payload selector 501 and the reverberator method type selector 503.

Thus when reverberation parameters are encoded as frequency data, the decoder is configured to revert the possible encoding. In an example embodiment the decoder is configured to implement Huffman decoding and reverting the differential encoding to obtain frequency dependent RT60(k) and log RDR(k) data.

In some embodiments the decoder 505, when the reverberation parameters are encoded as octave band data, is configured to decode the parameters by reverting the Huffman coding and differential encoding applied on the octave band values. In this case no band centre frequencies are transmitted as they are known by the renderer. Thus, decoded values directly correspond to RT60(b) and log RDR(b) where b is the octave band index (in other words the ‘frequency data’ mapping described hereafter is not employed).

In some embodiments the reverberator controller 301 further comprises a mapper 507 configured to map the frequency dependent data into octave band data RT60(b) and log RDR(b) where b is the octave band index. The values DDR(k) are mapped to a set of frequency bands b, which can be, e.g., either octave or third octave bands. Mapping of input DDR values to frequency bands b is done by obtaining for each band b the value from the input DDR response DDR(k) at the closest frequency k to the center frequency of band b. Other choices such as Bark bands or frequency bands with linearly-spaced center frequencies are also possible. This results in the frequency mapped DDR values DDR(b) and RT60 values RT60(b).

In some embodiments the reverberator controller 301 comprises a Filter parameter determiner 509 configured to convert the bandwise RT60(b) and log RDR(b) into reverberator parameters. The reverberator parameters can, in some embodiments, comprise the coefficients of each attenuation filter GEQ_{d}, feedback matrix coefficients A, and lengths m_{d} for D delay lines. In this invention, each attenuation filter GEQ_{d} is a graphic EQ filter using M biquad IIR band filters.

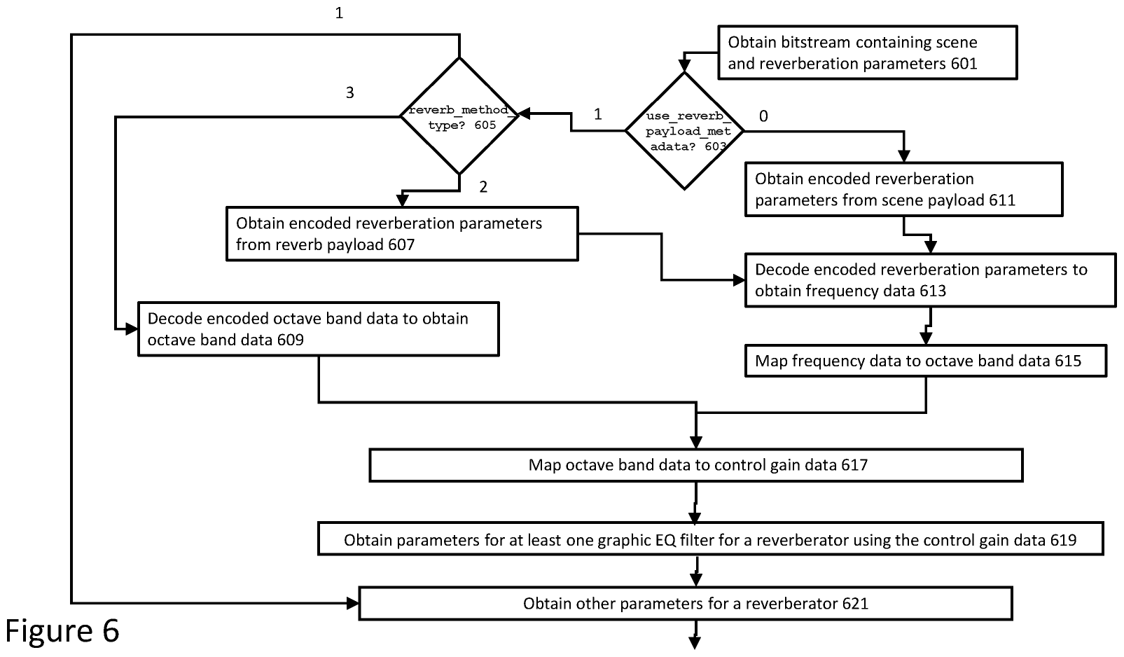

With respect to FIG. 6 is shown the operations of the reverberator controller 301 as shown in FIG. 5.

The first operation is one of obtaining the bitstream containing scene and reverberation parameters as shown in FIG. 6 by step 601.

Then a selection is made to determine whether to obtain the encoded reverberation parameters from the scene payload or from the reverb payload (or in other words whether they are to be obtained from the scene metadata or reverb metadata). This is shown in FIG. 6 by step 603.

Where the selection is made to obtain the encoded reverberation parameters from the scene payload (use_reverb_payload_metadata==0) then the next operation is one of obtaining the encoded reverberation parameters from the scene payload as shown in FIG. 6 by step 611.

Then having obtained the encoded reverberation parameters they can be decoded to obtain frequency data as shown in FIG. 6 by step 613.

The obtained frequency data can then be mapped to obtain octave band data as shown in FIG. 6 by step 615.

The octave band data can then be mapped to control gain data as shown in FIG. 6 by step 617.

The control gain data can then be used to obtain parameters for at least one graphic equalization filter for the reverberator as shown in FIG. 6 by step 619.

Where the selection is made to obtain the encoded reverberation parameters from the reverb payload metadata (use_reverb_payload_metadata==1) then the next operation is one of determining the reverberation method type as shown in FIG. 6 by step 605.

In this example, where the method indicates that the parameters are derived/determined in the renderer and from encoded frequency data (reverb_method_type==2) then the encoded reverberation parameters can be obtained from the reverb payload as shown in FIG. 6 by step 607. Then the method can pass to step 613 of decoding the encoded reverberation parameters to obtain frequency data as described above.

Furthermore where the method indicates that the parameters are derived/determined in the renderer (reverb_method_type==3) but from encoded octave band data then the encoded reverberation parameters can be obtained from decoding the encoded octave band data to obtain the octave band data as shown in FIG. 6 step 609. Then the method can pass to step 617 of mapping the octave band data to generate control gain data as described above.

Furthermore where the method indicates that the adjusted reverberator parameters are included in the reverberation payload (and have been derived/determined in the encoder) then the method can pass directly to the operation of obtaining the reverberator parameters as shown in FIG. 6 by step 621.

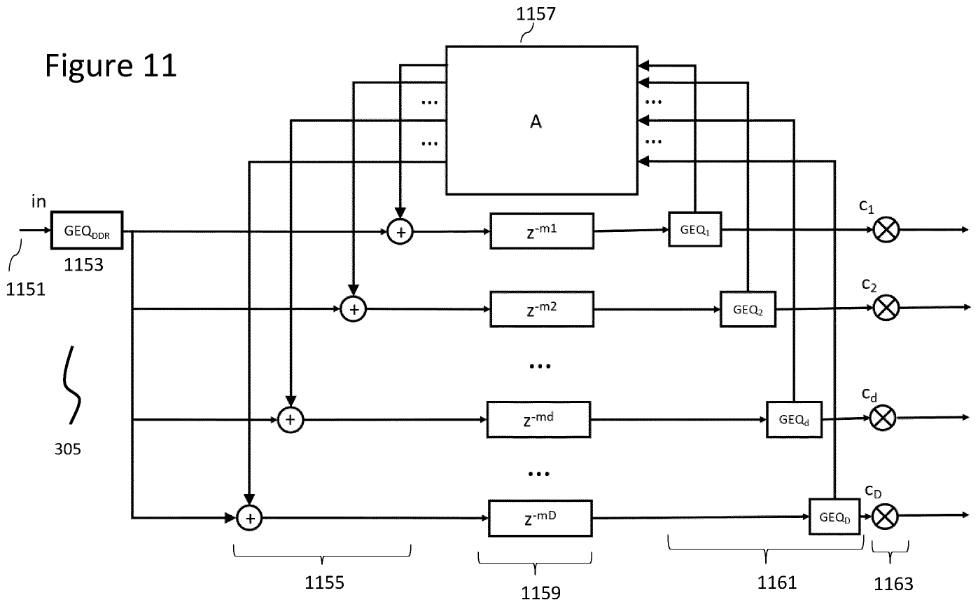

The generation of reverberator parameters are discussed herein in further detail and with respect to an example reverberator 305 as shown schematically in FIG. 11 as a FDN (Feedback Delay Network) configuration. The reverberator 305 which is enabled or configured to produce reverberation whose characteristics match the room parameters. There may be several of such reverberators, each parameterized based on the reverberation characteristics of an acoustic environment. An example reverberator implementation comprises a feedback delay network (FDN) reverberator and DDR control filter which enables reproducing reverberation having desired frequency dependent RT60 times and levels. The room (or reverberation) parameters are used to adjust the FDN reverberator parameters such that it produces the desired RT60 times and levels. An example of a level parameter can be the direct-to-diffuse-ratio (DDR) (or the diffuse-to-total energy ratio as used in MPEG-I). The output from the FDN reverberator are the reverberated audio signals which for binaural headphone reproduction are then reproduced into two output signals and for loudspeaker output means typically more than two output audio signals. Reproducing several outputs such as 15 FDN delay line outputs to binaural output can be done, for example, via HRTF filtering.

FIG. 11 shows an example FDN reverberator in further detail and which can be used to produce D uncorrelated output audio signals. In this example each output signal can be rendered at a certain spatial position around the listener for an enveloping reverb perception.

The example FDN reverberator is configured such that the reverberation parameters are processed to generate coefficients GEQ_{d} (GEQ₁, GEQ₂, . . . . GEQ_{D}) of each attenuation filter 1161, feedback matrix 1157 coefficients A, lengths m_{d} (m₁, m₂, . . . m_{D}) for D delay lines 1159 and DDR energy ratio control filter 1153 coefficients GEQ_{ddr}. The example FDN reverberator 305 thus shows a D-channel output, by providing the output from each FDN delay line as a separate output.

In some embodiments each attenuation filter GEQ_{d} 1161 is implemented as a graphic EQ filter using M biquad IIR band filters. With octave bands M=10, thus, the parameters of each graphic EQ comprise the feedforward and feedback coefficients for biquad IIR filters, the gains for biquad band filters, and the overall gain.

The reverberator uses a network of delays 1159, feedback elements (shown as attenuation filters 1161, feedback matrix 1157 and combiners 1155 and output gain 1163) to generate a very dense impulse response for the late part. Input samples 1751 are input to the reverberator to produce the reverberation audio signal component which can then be output.

The FDN reverberator comprises multiple recirculating delay lines. The unitary matrix A 1157 is used to control the recirculation in the network. Attenuation filters 1161 which may be implemented in some embodiments as graphic EQ filters implemented as cascades of second-order-section IIR filters can facilitate controlling the energy decay rate at different frequencies. The filters 1161 are designed such that they attenuate the desired amount in decibels at each pulse pass through the delay line and such that the desired RT60 time is obtained.

Thus with reverb_method_type==1, where the adjusted reverberator parameters are included in the scene and reverberation parameters. For the FDN reverberator the parameters contain the coefficients of each attenuation filter GEQ_{d}, feedback matrix coefficients A, and lengths m_{d} for D delay lines. Not all the parameters need to be adjusted/obtained but can utilize constant defined values. For example the feedback matrix coefficients A can be tabulated and stored in the renderer or implemented in software and only some parameters adjusted based on the room parameters. In this invention, each attenuation filter GEQ_{d} is a graphic EQ filter using M biquad IIR band filters.

With octave bands M=10, thus, the parameters of each graphic EQ comprise the feedforward b and feedback a coefficients for 10 biquad IIR filters, the gains for biquad band filters, and the overall gain.

The number of delay lines D can be adjusted depending on quality requirements and the desired tradeoff between reverberation quality and computational complexity. In an embodiment, an efficient implementation with D=15 delay lines is used. This makes it possible to define the feedback matrix coefficients A as proposed by Rocchesso in Maximally Diffusive Yet Efficient Feedback Delay Networks for Artificial Reverberation, IEEE Signal Processing Letters, Vol. 4. No. 9, September 1997, in terms of a Galois sequence facilitating efficient implementation.

A length m_{d} for the delay line d can be determined based on virtual room dimensions. Here, we use the dimensions of the enclosure. For example, a shoebox shaped room can be defined with dimensions xDim, yDim, zDim. When the method is executed in the apparatus for reverb_method_type==1 the dimensions are obtained from the encoder input file. When reverb_method_type==2 or reverb_method_type==3 the dimensions are obtained from the encoder input file (by the encoder device), included into the scene payload of the bitstream, and obtained by the renderer from the scene payload. When the input to the renderer is an AR scene with a listening space description file the dimensions are obtained from the listening space description. If the room is not shaped as a shoebox (or cuboid) then a shoebox can be fit inside the room and the dimensions of the fitted shoebox can be utilized for obtaining the delay line lengths. Alternatively, the dimensions can be obtained as three longest dimensions in the non-shoebox shaped room, or other suitable method. Such dimensions can also be obtained from a mesh if the bounding box is provided as a mesh. The dimensions can further be converted to modified dimensions of a virtual room or enclosure having the same volume as the input room or enclosure. For example, the ratios 1, 1.3, and 1.9 can be used for the converted virtual room dimensions. When the method is executed in the renderer (reverb_method_type==2 or reverb_method_type==3) then the enclosure vertices are obtained from the bitstream and the dimensions can be calculated, along each of the axes x, y, z, by the difference of the maximum and minimum value of the vertices. Dimensions can be calculated the same way when the input is an AR scene to be rendered with a listening space description with the difference that the enclosure vertices are obtained from the listening space description and not from the bitstream.

The delays can in some embodiments be set proportionally to standing wave resonance frequencies in the virtual room or physical room. The delay line lengths ma can further be made mutually prime.

The attenuation filter coefficients in the delay lines can furthermore be adjusted so that a desired amount in decibels of attenuation happens at each signal recirculation through the delay line so that the desired RT60(k) time is obtained. This is done in a frequency specific manner to ensure the appropriate rate of decay of signal energy at specified frequencies k.

For a frequency k, the desired attenuation per signal sample is calculated as attenuationPerSample(k)=−60/(samplingRate*rt60(k)). The attenuation in decibels for a delay line of length m_{d} is then attenuationDb(k)=m_{d}*attenuationPerSample(k).

Furthermore when reverberator parameters are derived in the encoder (reverb_method_type==1), the attenuation filters are designed as cascade graphic equalizer filters as described in V. Välimäki and J. Liski, “Accurate cascade graphic equalizer,” IEEE Signal Process. Lett., vol. 24, no. 2, pp. 176-180, February 2017, for each delay line. The design procedure outlined takes as input a set of command gains at octave bands. There are also methods for a similar graphic EQ structure which can support third octave bands, increasing the number of biquad filters to 31 and providing better match for detailed target responses such as indicated in Third-Octave and Bark Graphic-Equalizer Design with Symmetric Band Filters, https://www.mdpi.com/2076-3417/10/4/1222/pdf.

When reverberator parameters are derived in the renderer (reverb_method_type==2 or reverb_method_type==3 or an AR scene), a neurally controlled graphic equalizer design such as described in Välimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019 can be used. Furthermore in some embodiments if the method designs third octave graphic EQ then the method of Third-Octave and Bark Graphic-Equalizer Design with Symmetric Band Filters, https://www.mdpi.com/2076-3417/10/4/1222/pdf can be employed.

Reverberation ratio parameters can refer to the diffuse-to-total energy ratio (DDR) or reverberant-to-direct ratio (RDR) or other equivalent representation. The ratio parameters can be equivalently represented on a linear scale or logarithmic scale.

A filter is designed in the step such that, when the filter is applied to the input data of the FDN reverberator, the output reverberation is configured to have the desired energy ratio defined by the DDR(k). The input to the design procedure can in some embodiments be the DDR values DDR(k).

When receiving linear DDR values DDR(b), the values can be converted to linear RDR values as

$$RDR ( b ) = DDR ( b ) * {10}^{( 41 / 10 )}$$

When receiving logarithmic RDR values log RDR(b), the values can be converted to linear RDR values as

$$RDR ( b ) = 1 {0}^{( logRDR ( b ) / 10 )}$$

The GEQ_{DDR} matches the reverberator spectrum energy to the target spectrum energy. In order to do this, an estimate of the RDR of the reverberator output and the target RDR is obtained. The RDR of the reverberator output can be obtained by rendering a unit impulse through the reverberator using the first reverberator parameters (that is, the parameters of the FDN without the GEQ_{DDR} filter the parameters of which are being obtained) and measuring the energy of the reverberator output and energy of the unit impulse and calculating the ratio of these energies.

In some embodiments a unity impulse input is generated where the first sample value is 1 and the length of the zero tail is long enough. In practice, we have adjusted the length of the zero tail to equal max (RT60(b)) plus the t_{predelay} in samples. The monophonic output of the reverberator is of interest so the filter is configured to sum over the delay lines j to obtain the reverberator output sᵣₑᵥ(t) as a function of time t.

A long FFT (of length NFFT) is calculated over sᵣₑᵥ(t) and its absolute value is obtained as

$$FFA ( k k ) = abs ( FF T ( {s}_{r e v} ( t ) )$$

Here, kk are the FFT bin indices. The positive half spectral energy density is obtained as

$$S ( k k ) = 1 / NFFT * {FFA ( k k )}^{2}$$

where the energy from the negative frequency indices kk is added into the corresponding positive frequency indices kk.

The energy of a unit impulse can be calculated or obtained analytically and can be denoted as Su(kk).

Band energies are calculated of both the positive half spectral energy density of the reverberator S(kk) and the positive half spectral energy density of the unit impulse Su(kk). Band energies can be calculated as

$$S ( b ) = {\sum }_{k k = {b}_{l o w}}^{{b}_{high}} S ( k k )$$

where b_{low} and b_{high} are the lowest and highest bin index belonging to band b, respectively. The band bin indices can be obtained by comparing the frequencies of the bins to the lower and upper frequencies of each band.

The reproduced RDRᵣₑᵥ(b) of the reverberator output at the frequency band b is obtained as

$${RDR}_{r e v} ( b ) = S ( b ) / Su ( b )$$

The target linear magnitude response for GEQ_{DDR} can be obtained as

ddrFilterTargetResponse(b)=sqrt(RDR(b))/sqrt(RDRᵣₑᵥ(b))

where RDR(b) is the linear target RDR value mapped to frequency band b.

GontrolGain(b)=20*log 10(ddrFilterTargetResponse(b)) is input as the target response for the graphic equalizer design routine in Välimäki, Rämö, “Neurally Controlled Graphic Equalizer”, IEEE/ACM TRANSACTIONS ON AUDIO, SPEECH, AND LANGUAGE PROCESSING, VOL. 27, NO. 12, December 2019.

The DDR filter target response (control gains for the graphic EQ design routine) can also be obtained directly in the logarithmic domain as

$$ControlGain ( b ) = 10 {log}_{10} ( RDR ( k ) ) - 10 {log}_{10} ( {RDR}_{r e v} ( b ) )$$

The first reverberator parameters and the parameters of the Reverberator DDR control filter GEQ_{DDR} together form the reverberator parameters.

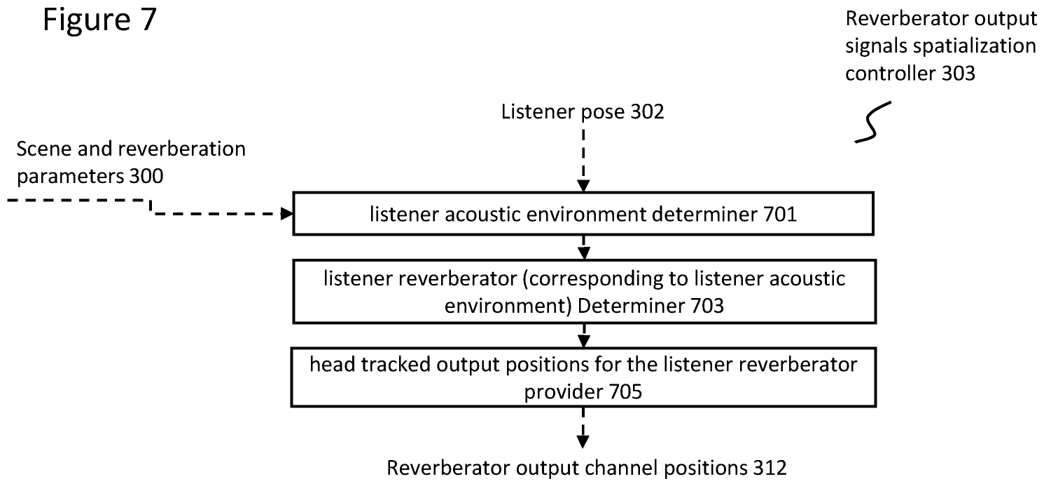

With respect to FIG. 7 there is shown in further detail the reverberator output signals spatialization controller 303 as shown in FIG. 3.

The reverberator output signals spatialization controller 303 is configured to receive the scene and reverberator parameters 300 and listener pose parameters 302. The reverberator output signals spatialization controller 303 is configured to use the listener pose parameters 302 and scene and reverberator parameters 300 to determine the acoustic environment where the listener currently is and provide that reverberator output channels such positions which surround the listener. This means that the reverberation when inside an acoustic enclosure, caused by that acoustic enclosure, is rendered as a diffuse signal enveloping the listener.

In some embodiments the reverberator output signals spatialization controller 303 comprises a listener acoustic environment determiner 701 configured to obtain the scene and reverberator parameters 300 and listener pose parameters 302 and determine the listener acoustic environment.

In some embodiments the reverberator output signals spatialization controller 303 comprises a listener reverberator corresponding to listener acoustic environment determiner 703 which is further configured to determine listener reverberator corresponding to listener acoustic environment information.

In some embodiments the reverberator output signals spatialization controller 303 comprises a head tracked output positions for the listener reverberator provider 705 configured to provide or determine the head tracked output positions for the listener and generate the output channel position 312.

The output of the reverberator output signals spatialization controller 303 is thus the reverberator output channel positions 312.

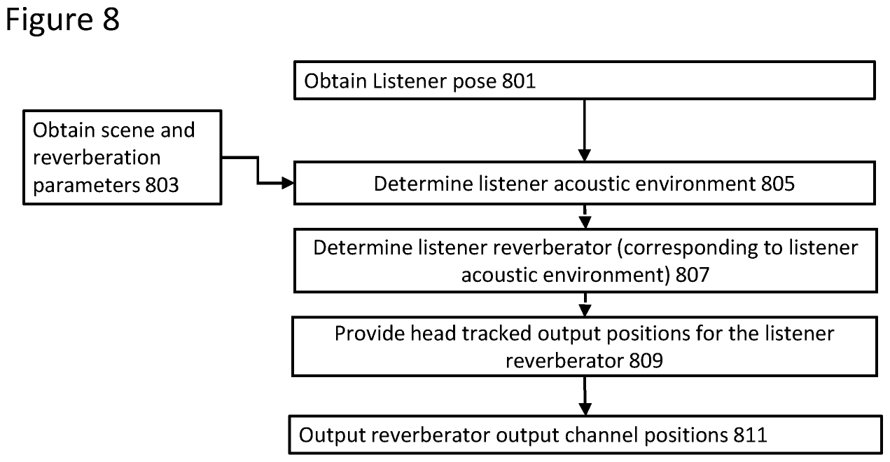

With respect to FIG. 8 is shown the operations of an example reverberator output signals spatialization controller 303 according to some embodiments.

Thus for example is shown obtaining scene and reverberator parameters as shown in FIG. 8 by step 803 and obtaining listener pose parameters as shown in FIG. 8 by step 801.

Then the method comprises determining listener acoustic environment as shown in FIG. 8 by step 805.

Having determined this then determine listener reverberator corresponding to listener acoustic environment as shown in FIG. 8 by step 807.

Further the method comprises providing head tracked output positions for the listener reverberator as shown in FIG. 8 by step 809.

Then outputting reverberator output channel positions as shown in FIG. 8 by step 811.

In some embodiments, the reverberator corresponding to the acoustic environment where the user currently is, is rendered by the reverberator output signals spatializer 307 as an immersive audio signal surrounding the user. That is, the signals in s_{rev,r}(j,t) corresponding to the listener environment are rendered as point sources surrounding the listener.

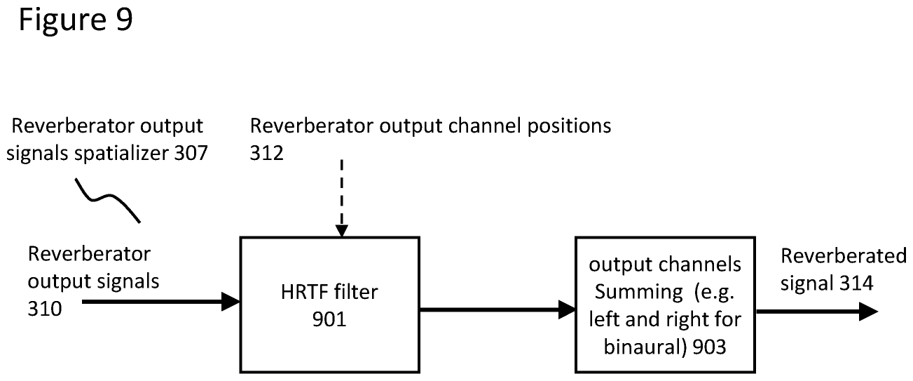

With respect to FIG. 9 there is shown in further detail the reverberator output signals spatializer 307. The reverberator output signals spatializer 307 is configured to receive the positions 312 from the reverberator output signals spatialization controller 303. Additionally is received the reverberator output signals 310 from the reverberators 305.

In some embodiments the reverberator output signals spatializer comprises a head-related transfer function (HRTF) filter 901 which is configured to render each reverberator output into a desired output format (such as binaural).

Furthermore in some embodiments the reverberator output signals spatializer comprises a output channels combiner 903 which is configured to combine (or sum) the signals to produce the output reverberated signal 314.

Thus for example for binaural reproduction the reverberator output signals spatializer 307 can use HRTF filtering to render the reverberator output signals in their desired positions indicated by reverberator output channel positions.

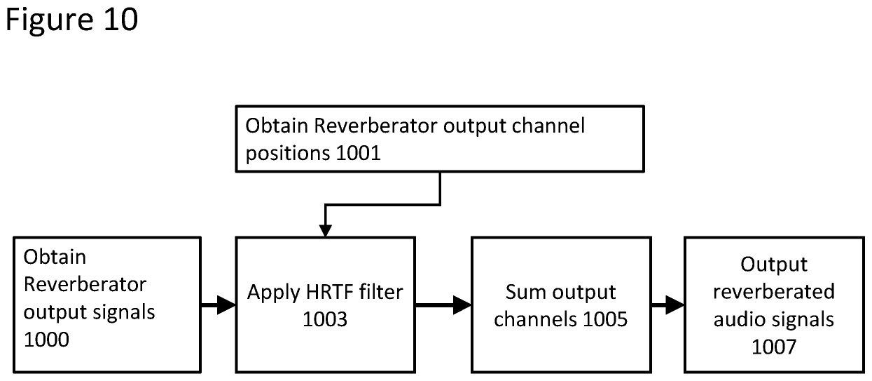

With respect to FIG. 10 is shown a flow diagram showing the operations of the reverberator output signals spatializer according to some embodiments.

Thus the method can comprise obtaining reverberator output signals as shown in FIG. 10 by step 1000 and obtaining reverberator output channel positions as shown in FIG. 10 by step 1001.

Then the method may comprise applying a HRTF filter configured by the reverberator output channel positions to the reverberator output signals as shown in FIG. 10 by step 1003.

The method may then comprise summing or combining the output channels as shown in FIG. 10 by step 1005.

Then the reverberated audio signals can be output as shown in FIG. 10 by step 1007.

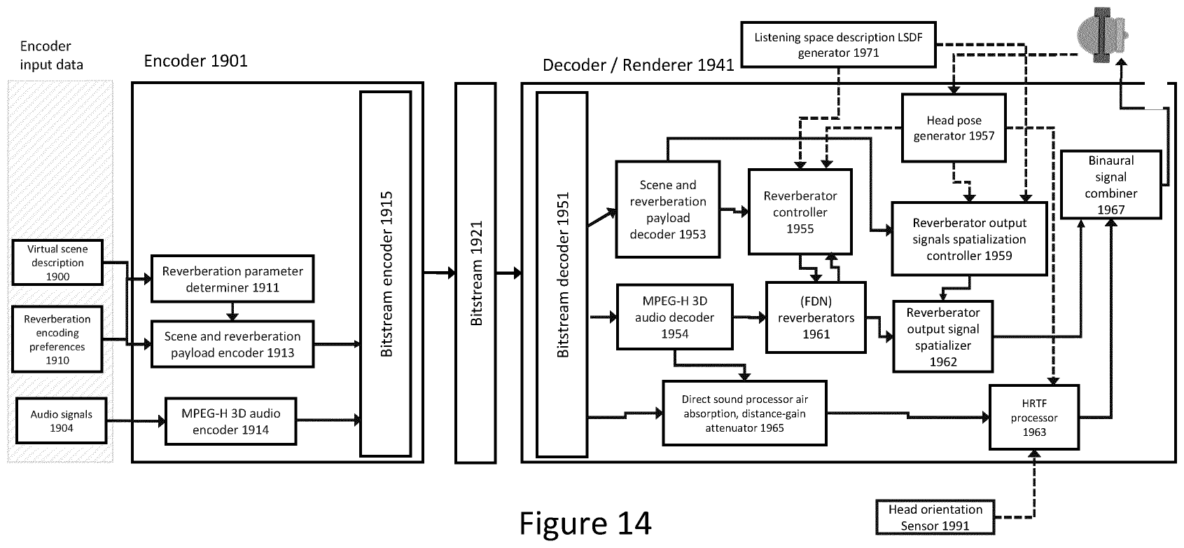

FIG. 14 shows schematically an example system where the embodiments are implemented in an encoder device 1901 which performs part of the functionality; writes data into a bitstream 1921 and transmits that for a renderer device 1941, which decodes the bitstream, performs reverberator processing according to the embodiments and outputs audio for headphone listening. FIG. 14 for example shows apparatus, and specifically the renderer device 1941, which is suitable for performing spatial rendering operations.

The encoder side 1901 of FIG. 14 can be performed on content creator computers and/or network server computers. The output of the encoder is the bitstream 1921 which is made available for downloading or streaming. The decoder/renderer 1941 functionality runs on end-user-device, which can be a mobile device, personal computer, sound bar, tablet computer, car media system, home HiFi or theatre system, head mounted display for AR or VR, smart watch, or any suitable system for audio consumption.

The encoder 1901 is configured to receive the virtual scene description 1900 and the audio signals 1904. The virtual scene description 1900 can be provided in the MPEG-I Encoder Input Format (EIF) or in other suitable format. Generally, the virtual scene description contains an acoustically relevant description of the contents of the virtual scene, and contains, for example, the scene geometry as a mesh, acoustic materials, acoustic environments with reverberation parameters, positions of sound sources, and other audio element related parameters such as whether reverberation is to be rendered for an audio element or not. The encoder 1901 in some embodiments comprises a reverberation parameter determiner 1911 configured to receive the virtual scene description 1900 and configured to obtain the reverberation parameters. The reverberation parameters can in an embodiment be obtained from the RT60, DDR, predelay, and region/enclosure parameters of acoustic environments.

The encoder 1901 furthermore in some embodiments comprises a scene and reverberation payload encoder 1913 configured to obtain the determined reverberation parameters and virtual scene description 1900 and generate suitable encoded scene and reverberation parameters.

The encoder 1901 on FIG. 14 can be executed on content creator computers and/or network server computers. The output of the encoder is the bitstream which is made available for downloading or streaming. It can reside on a content delivery network (CDN) for example. The decoder/renderer 1941 functionality in some embodiments runs on an end-user-device, which can be a mobile device, personal computer, sound bar, tablet computer, car media system, home HiFi or theatre system, head mounted display for AR or VR, smart watch, or any suitable system for audio consumption.

In the embodiments described herein the scene and reverberation parameters are encoded into a bitstream payload referred as a reverberation payload (generated by the scene and reverberation payload encoder 1913). In some embodiments, an input reverberation encoding preferences 1910, in the form of use_reverb_payload_metadata and reverb_method_type, is provided to the reverberation parameter determiner 1911 and the scene and reverberation payload encoder 1913. Depending on the obtained use_reverb_payload_metadata, the encoder 1901 is configured to derive and write reverberator or compact reverberation parameters into the reverberation payload part (use_reverb_payload_metadata==1) or into the scene payload part (use_reverb_payload_metadata==0). Furthermore in some embodiments and depending on the determined reverb_method_type, the encoder 1901 is configured to either derive reverberator parameters based on the reverberation parameters provided in the encoder input data (reverb_method_type==1), or encode reverberation parameters in a compact representation into bitstream (reverb_method_type==2 or reverb_method_type==3).

Deriving reverberator parameters based on reverberation parameters can be implemented in some embodiments as described in the obtained parameters for at least one graphic EQ filter for a reverberator using the control gain data and obtain other parameters for a reverberator as indicated above.

The encoder 1901 further comprises a MPEG-H 3D audio encoder 1914 configured to obtain the audio signals 1904 and MPEG-H encode them and pass them to a bitstream encoder 1915.

The encoder 1901 furthermore in some embodiments comprises a bitstream encoder 1915 which is configured to receive the output of the scene and reverberation payload encoder 1913 and the encoded audio signals from the MPEG-H encoder 1914 and generate the bitstream 1921 which can be passed to the bitstream decoder 1941. The bitstream 1921 in some embodiments can be streamed to end-user devices or made available for download or stored.

The decoder 1941 in some embodiments comprises a bitstream decoder 1951 configured to decode the bitstream.

The decoder 1941 further can comprise a reverberation payload decoder 1953 configured to obtain the encoded reverberation parameters and decode these in an opposite or inverse operation to the reverberation payload encoder 1913.

The listening space description LSDF generator 1971 is configured to generate and pass the LSDF information to the reverberator controller 1955 and the reverberator output signals spatialization controller 1959.

Furthermore the head pose generator 1957 receives information from a head mounted device or similar and generates head pose information or parameters which can be passed to the reverberator controller 1955, the reverberator output signals spatialization controller 1959 and HRTF processor 1963.

The decoder 1941, in some embodiments, comprises a reverberator controller 1955 which also receives the output of the scene and reverberation payload decoder 1953 and generates the reverberation parameters for configuring the reverberators and passes this to the reverberators 1961.

In some embodiments the decoder 1941 comprises a reverberator output signals spatialization controller 1959 configured to configure the reverberator output signals spatializer 1962.

The decoder 1941 in some embodiments comprises a MPEG-H 3D audio decoder 1954 which is configured to decode the audio signals and pass them to the (FDN) reverberators 1961 and direct sound processor 1965.

The decoder 1941 furthermore comprises (FDN) reverberators 1961 configured by the reverberator controller 1955 and configured to implement a suitable reverberation of the audio signals.

The output of the (FDN) reverberators 1961 is configured to output to a reverberator output signal spatializer 1962.

In some embodiments the decoder 1941 comprises a reverberator output signal spatializer 1962 configured to apply the spatialization and output to the binaural combiner 1967.

Additionally the decoder/renderer 1941 comprises a direct sound processor 1965 which is configured to receive the decoded audio signals and configured to implement any direct sound processing such as air absorption and distance-gain attenuation and which can be passed to a HRTF processor 1963 which with the head orientation determination (from a suitable sensor 1991) can generate the direct sound component which with the reverberant component from the HRTF processor 1963 is passed to a binaural signal combiner 1967. The binaural signal combiner 1967 is configured to combine the direct and reverberant parts to generate a suitable output (for example for headphone reproduction).

Furthermore in some embodiments the decoder comprises a head orientation determiner 1991 which passes the head orientation information to the HRTF processor 1963.

Although not shown, there can be various other audio processing methods applied such as early reflection rendering combined with the proposed methods.

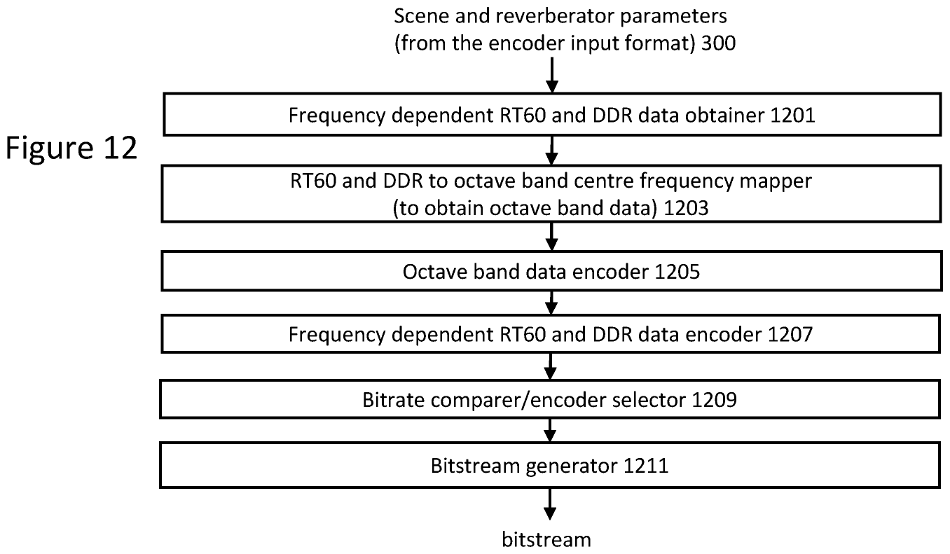

With respect to FIG. 12 is shown the example reverberation payload encoder 1913 in further detail.

In some embodiments the reverberation payload encoder 1913 comprises a frequency dependent RT60 and DDR data obtainer 1201 configured to obtain the frequency dependent RT60 and DDR data values. Where an acoustic environment has reverberation parameters described with RT60(k) and DDR(k). DDR(k) can be converted to logarithmic log RDR(k) with

$$log RDR ( k ) = 10 * log 10 ( RDR ( k ) ) = 10 * log 10 ( DDR ( k ) ) + 41 dB .$$

In some embodiments the reverberation payload encoder 1913 comprises a RT60 and DDR to octave band centre frequency mapper (to obtain octave band data) 1203 which is configured map the obtained RT60 and DDR values to a octave band centre frequencies. This can be implemented by mapping each frequency k to the closest octave band centre frequency b. The band centre frequencies can in some embodiments be the following (in Hz):

$$bandCenterFreqs = [ \begin{matrix}31.25 & 62.5 & 125 & 250 & 500 & 1000 & 2000 & 4000 & 8000 & 16000\end{matrix} ]$$

Weighted linear interpolation can be used to obtain the value of the RT60(b) or log RDR(b) at each band centre frequency. If no data is provided above a certain band or below certain band, the last band value is extrapolated to higher bands (or the first band value is extrapolated to lower bands).

In some other embodiments other predefined frequency band divisions can be utilized. Frequency band divisions can be indicated with a set of centre frequencies like above, or with a set of band low and band high frequencies. A predefined number of frequency band divisions can be known by the encoder and renderer. Each frequency band division can be optionally identified with a unique identifier such as a unique index related to frequency band divisions. Such identifiers and corresponding divisions can be known by the encoder and renderer. In some embodiments new divisions can be formed by the encoder and then signalled to the renderer. In some embodiments the encoder can evaluate different frequency band divisions for mapping the frequency dependent input data. If a predefined number of input frequencies almost coincide with a number of centre frequencies in a frequency band division data, then a good match between the input data and the corresponding frequency band division data can be determined. This kind of evaluation can be performed by the encoder for a plurality of frequency band divisions and the frequency band division which best represents the input data, based on the criterion described above, can be selected for representing the input data. Data can then be encoded by sending the values of the input data mapped to the centre frequencies of the selected frequency band division, and the identifier of the used frequency band division. In some embodiments the frequency band divisions have different numbers of frequency bands which means that explicit identifiers are not needed but the renderer can identify the used frequency band division from the number of values.

In some embodiments the reverberation payload encoder 1913 comprises an octave band data encoder 1205. The octave band data encoder 1205 in some embodiments is configured to encode the octave band data by differential encoding methods. For example taking the first value and then encoding the rest of the values as their differences to the first value. The bitstream can contain the first value as such and Huffman codes of the difference values. In some embodiments such differential encoding is not applied but the octave band values are encoded into the bitstream as suitable integer values.

The reverberation payload encoder 1913 comprises a frequency dependent RT60 and DDR data encoder 1207. The frequency dependent RT60 and DDR data encoder 1207 is configured to encode the frequency-dependent RT60(k) and DDR(k) data. If the frequency values k are shared between these, then the frequency values need to be encoded only once. They can be difference encoded and Huffman coded like octave band data. Similarly, RT60(k) and DDR(k) can be difference encoded and Huffman coded. In some embodiments the difference encoding and/or Huffman coding are omitted and the values are included into the bitstream as suitable integer values.

Furthermore in some embodiments the reverberation payload encoder 1913 comprises a bitrate comparer/encoder selector 1209, the selector 1209 is configured to compare the bitrate required for transmitting the encoding from the octave band data encoder 1205 and frequency dependent RT60 and DDR data encoder 1207 and select one to be transmitted as compact reverberation parameters. The number of bits required by transmitting the first value and the Huffman codes of the remaining values are compared for the data representations of both encoder options. The one leading to smallest number of bits is selected, and reverb_method_type is set accordingly to type 2 or type 3.

In some embodiments the reverberation payload encoder 1913 comprises a bitstream generator 1211 configured to create a bitstream representation of the selected compact reverberation parameters.

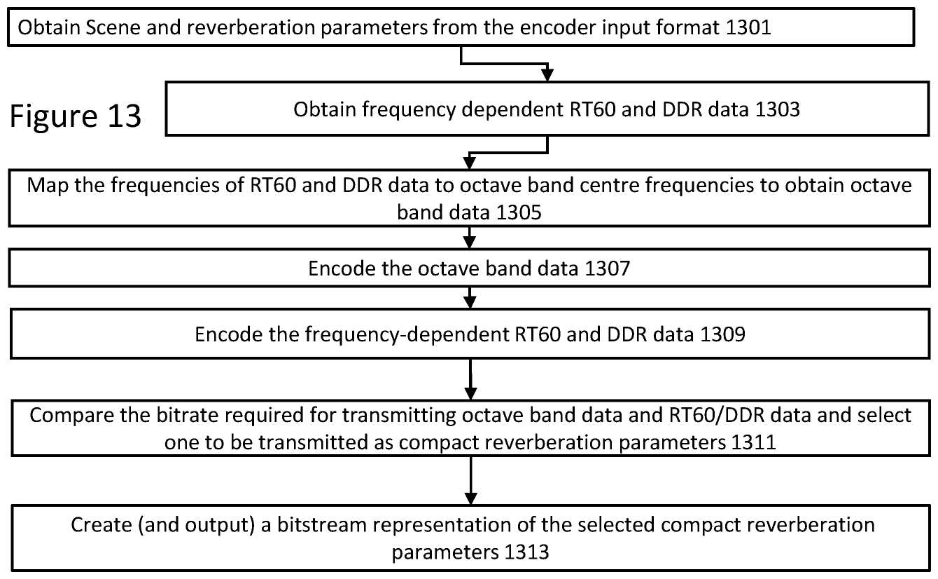

With respect to FIG. 13 the operation of the encoder shown in FIG. 12 is shown according to some embodiments.

First is the operation of obtaining Scene and reverberation parameters from the encoder input format as shown in FIG. 13 by step 1301.

Then is the operation of obtaining frequency dependent RT60 and DDR data as shown in FIG. 13 by step 1303.

The next step is one of mapping the frequencies of RT60 and DDR data to octave band centre frequencies to obtain octave band data as shown in FIG. 13 by step 1305.

Then the method comprises encoding the octave band data as shown in FIG. 13 by step 1307 and encoding the frequency-dependent RT60 and DDR data as shown in step 1309.

The next operation is one of comparing the bitrate required for transmitting octave band data and RT60/DDR data and select one to be transmitted as compact reverberation parameters as shown in FIG. 13 by step 1311.

Then the next step is to create (and output) a bitstream representation of the selected compact reverberation parameters as shown in FIG. 13 by step 1313.

The bitstream can thus carry the information for low bitrate representation of metadata for late reverberation in different methods.

Reverb parameters represent filter coefficients for the FDN reverberator attenuation filters and the ratio control filter (DDR control filter), the delay line lengths, and spatial positions for the output delay lines. Other FDN parameters such as feedback matrix coefficients can be predetermined in the encoder and renderer and not included in the bitstream.

Encoded reverberation parameters carry RT60 and DDR data in the bitstream, encoded either as frequency dependent data with the frequencies at which the values are provided, or just as (interpolated) values at octave bands (without transmitting the octave band centre frequencies). Other frequency band divisions can be used in some embodiments.

RT60 times mapped into control gains of a graphic EQ (FDN attenuation filter). There are either 10 or 31 control gains. DDR values mapped into control gains of a graphic EQ. There are either 10 or 31 control gains.

This can be implemented in an example structure such as the following:

```
reverbPayloadStruct( ) {
  unsigned int(1) use_reverb_payload_metadata;//decides if reverb or
scene payload is used
  if(use_reverb_payload_metadata) { unsigned int(2)
reverb_method_type; // 1 means current method, 2 means RT60 and
DDR encoded, 3 means RT60 and DDR octave band data
    reserved bits(6) = 0;
    if(reverb_method_type==1)
    {
      unsigned int(2) numberOfSpatialPositions;
      unsigned int(8) numberOfAcousticEnvironments;
      for(int i=0;i<numberOfSpatialPositions;i++) {
        signed int(32) azimuth;
        signed int(32) elevation;
      }
      for(int i=0;i<numberOfAcousticEnvironments;i++) {
        unsigned int(16) environmentsId;
        filterParamsStruct( );
        for(int j=0;j<numberOfSpatialPositions;j++) {
          unsigned int(32) delayLineLength;
          filterParamsStruct( );
        }
      }
    }
    else if (reverb_method_type == 2) {
      for(int i=0;i<numberOfAcousticEnvironments;i++) {
        unsigned int(16) environmentsId;
        EncodedRT60Struct( ); //frequency values can be
differentially and Huffman coded with values for RT60 values. So
basically it will be 2 unsigned int per frequency bin.
        EncodedDDRStruct( );
        ReverbEnclosureStruct( );
        }
      }
    }
    else if (reverb_method_type == 3) {
      for(int i=0;i<numberOfAcousticEnvironments;i++) {
        unsigned int(16) environmentsId;
        RT60OctaveBandsDataStruct( ); //10 bands
        DDROctaveBandsDataStruct( ); //10 bands
        ReverbEnclosureStruct( ); //8 vertices
        }
      }
    }
  }
}
aligned(8) filterParamsStruct( ) {
  SOSLength;
  If(SOSLength>0) {
    for (i=0;i<SOSLength;i++) {
      signed int(32) b1;
    }
    for (i=0;i<SOSLength;i++) {
      signed int(32) b2;
    }
    for (i=0;i<SOSLength;i++) {
      signed int(32) a1;
    }
    for (i=0;i<SOSLength;i++) {
      signed int(32) a2;
    }
  signed int(32) globalGain;
  signed int(32) levelDb;
  }
  }
aligned(8) PositionStruct( ) {
  signed int(32) vertex_pos_x;
  signed int(32) vertex_pos_y;
  signed int(32) vertex_pos_z;
}
aligned(8) ReverbEnclosureStruct( ) {
  unsigned int(8) num_vertices; //vertices for the enclosure
  for (i=0;i<num_vertices;i++) {
    PositionStruct( );
  }
}
aligned(8) EncodedRT60Struct( ) {
  unsigned int(8) num_frequency_bands;
  for (i=0;i<num_frequency_bands;i++) {
    unsigned int(32) frequency_encoded_value;
    unsigned int(32) scene_rt60_encoded_value;
  }
}
aligned(8) EncodedDDRStruct( ) {
  unsigned int(8) num_frequency_bands;
  for (i=0;i<num_frequency_bands;i++) {
    unsigned int(32) frequency_encoded_value;
    unsigned int(32) scene_ddr_encoded_value; //represented as
logRDR, Huffman coded
  }
}
aligned(8) RT60OctaveBandDataStruct( ) { //fixed octave bands in the
renderer
  for (i=0;i<10;i++) {
    unsigned int(32) rt60_encoded_value; //Huffman coded
  }
}
  aligned(8) DDROctaveBandDataStruct( ) { //fixed octave bands in the
  renderer
  for (i=0;i<10;i++) {
    unsigned int(32) ddr_encoded_value; //represented as logRDR,
Huffman coded
  }
}
```

The Semantics of the structure reverbPayloadStruct( ) use_reverb_payload_metadata equal to 1 indicates to the renderer that the metadata carried in the reverb payload data structure should be use to perform late reverberation rendering. A value equal to 0 indicates to the renderer that the metadata from scene payload shall be used to perform late reverberation rendering.
reverb_method_type equal to 1 indicates to the renderer that the metadata carries information with encoder optimized reverb parameters for the FDN. A value equal to 2 indicates that the carriage of reverberation metadata carries encoded representation of the RT60 and DDR. A value equal to 3 carried in the reverb payload data carries octave band data for RT60 and DDR.
numberOfSpatialPositions defines the number of output delay line positions for the late reverb payload. This value is defined using an index which corresponds to a specific number of delay lines. The value of the bit string ‘0b00’ signals the renderer to a value of 15 spatial orientations for delay lines. The other three values ‘0b01’, ‘0b10’ and ‘0b11’ are reserved.
azimuth defines azimuth of the delay line with respect to the listener. The range is between −180 to 180 degrees.
elevation defines the elevation of the delay line with respect to the listener. The range is between −90 to 90 degrees.
numberOfAcousticEnvironments defines the number of acoustic environments in the audio scene. The reverbPayloadStruct( ) carries information regarding the one or more acoustic environments which are present in the audio scene at that time. An acoustic environment has certain “Reverberation parameters” such as RT60 times which are used to obtain FDN reverb parameters.
environmentId This value defines the unique identifier of the acoustic environment. delayLineLength defines the length in units of samples for the graphic equalizer (GEQ) filter used for configuration of the delay line attenuation filter. The lengths of different delay lines corresponding to the same acoustic environment are mutually prime.
filterParamsStruct( ) this structure describes the graphic equalizer cascade filter to configure the attenuation filter for the delay lines. The same structure is also used subsequently to configure the filter for diffuse-to-direct reverberation ratio GEQ_{DDR}. The details of this structure are described in the next table.
If reverb_method_type is equal to 2, the bitstream comprises three structures:
EncodedRT60Struct( ) carries RT60 (scene_rt60_value) values for each frequency band (frequency_value) represented as positive integers. In an implementation embodiment, the integers are differentially encoded and Huffman coded integer indices.
EncodedDDRStruct( ) carries DDR values (scene_ddr_coded_value) for each frequency (frequency_value) band represented as positive integers. In an implementation embodiment, the DDR value is represented according to the equation log RDR(k)=10*log 10(RDR(k))=10*log 10(DDR(k))−41 dB, the integers are differentially encoded and Huffman coded integer indices.
The frequency bands can be the same or different for RT60 and DDR. The Huffman coding of differences can be same or different for RT60 and DDR.
   If reverb_method_type is equal to 3, the bitstream comprises three structures:
DDROctaveBandDataStruct( ) carries DDR values (ddr_encoded_value) for 10 Octave bands. In an implementation embodiment, the DDR value is represented according to equation log RDR(k)=10*log 10(RDR(k))=10*log 10(DDR(k))−41 dB, the integers are differentially encoded and Huffman coded integer indices. The DDR value is represented according to equation log RDR(k)=10*log 10(RDR(k))=10*log 10(DDR(k))−41 dB also.
RT60OctaveBandDataStruct( ) carries RT60 values (encoded_rt60_values) for 10 Octave bands. The RT60 values can be converted to a suitable integer representation in an embodiment. The integers are differentially encoded and Huffman coded integer indices.
   The Semantics of filterParamsStruct( )
   SOSLength is the length of the each of the second order section filter coefficients.
   b1, b2, a1, a2 The filter is configured with coefficients b1, b2, a1 and a2. These are the feedforward and feedback IIR filter coefficients of the second-order section IIR filters.
   globalGain specifies the gain factor in decibels for the GEQ.
   levelDB specifies a sound level offset for each of the delay lines in decibels.

All filterParamsStruct( ) get deserialized into a GEQ object in the renderer.

As indicated earlier MPEG-I Audio Phase 2 will normatively standardize the bitstream and the renderer processing. There will also be an encoder reference implementation, but it can be modified later on as long as the output bitstream follows the normative specification. This allows improving the codec quality also after the standard has been finalized with novel encoder implementations.

The portions going to different parts of the MPEG-I standard can be:
Encoder reference implementation will contain
   Deriving the reverberator parameters or compact reverberation parameters for each of the acoustic environments based on their RT60 and DDR
   Obtaining scene parameters from the encoder input and writing them into the bitstream.
   Writing a bitstream description containing the reverberator or compact reverberation parameters and scene parameters.
The normative bitstream shall contain reverberator or compact reverberation parameters described using the syntax described here. The bitstream shall be streamed to end-user devices or made available for download or stored.
The normative renderer shall decode the bitstream to obtain the Scene and reverberation parameters and perform the compact reverberation parameter decoding and mapping to reverberator parameters as described in the embodiments herein. Moreover, the renderer is configured to take care of reverberation rendering.
The complete normative renderer will also obtain other parameters from the bitstream related to room acoustics and sound source properties, and use them to render the direct sound, early reflection, diffraction, sound source spatial extent or width, and other acoustic effects in addition to diffuse late reverberation. The invention presented here focuses on the rendering of the diffuse late reverberation part and in particular how to enable bitrate efficient coding of compact reverberation parameters.

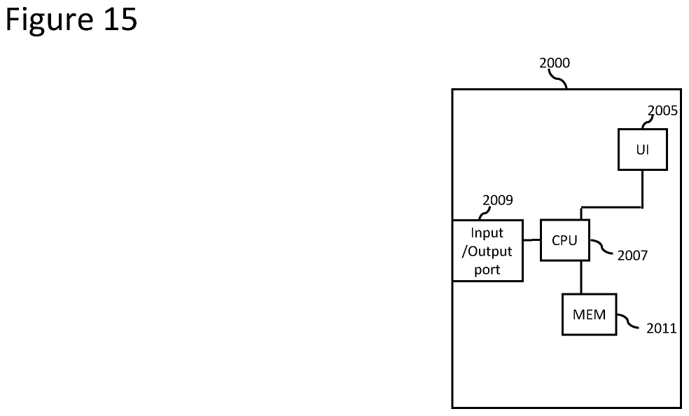

With respect to FIG. 15 an example electronic device which may be used as any of the apparatus parts of the system as described above. The device may be any suitable electronics device or apparatus. For example in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus for assisting spatial rendering in at least one acoustic environment, the apparatus comprising:
at least one processor; and
at least one memory storing instructions that, when executed with the at least one processor, cause the apparatus at least to:
obtain at least one reverberation parameter;
convert the obtained at least one reverberation parameter into at least one frequency band data;
encode the at least one frequency band data;
encode the at least one reverberation parameter;
compare resources required to transmit the encoded at least one frequency band data and the encoded at least one reverberation parameter; and
generate a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; or the encoded at least one reverberation parameter.

2. The apparatus as claimed in claim 1, wherein the at least one frequency band data is at least one of:
organised as octave bands; or
comprising an index identifying a centre band frequency range and a number of bands.

3. (canceled)

4. The apparatus as claimed in claim 1, wherein the instructions, when executed with the at least one processor, cause the apparatus to generate the bitstream comprising a selection indicator configured to indicate the selection, based on the comparison, of one or more of: the encoded at least one frequency band data; or the encoded at least one reverberation parameter within the bitstream.

5. The apparatus as claimed in claim 1, wherein the instructions, when executed with the at least one processor, cause the apparatus to obtain a scene description defining a virtual scene forming at least part of the at least one acoustic environment, wherein the at least one reverberation parameter is associated with the virtual scene.

6. The apparatus as claimed in claim 1, wherein the at least one reverberation parameter is a frequency dependent reverberation parameter.

7. The apparatus as claimed in claim 1, wherein the resources are one of:
encoded bitrate;
encoded bits; or
channel capacity.

8. The apparatus as claimed in claim 1, wherein the instructions, when executed with the at least one processor, cause the apparatus to:
select the encoded at least one reverberation parameter in a high bitrate mode; and
select the encoded at least one frequency band data in a low bitrate mode.

9. An apparatus for assisting spatial rendering in at least one acoustic environment, the apparatus comprising:
at least one processor; and
at least one memory storing instructions that, when executed, with the at least one processor, cause the apparatus at least to:
obtain a bitstream, the bitstream comprising: an identifier identifying the at least one acoustic environment; information defining at least one dimension of the at least one acoustic environment; and a reverberation parameter part comprising one of: an encoded at least one frequency band data or an encoded at least one reverberation parameter;
decode the reverberation parameter part to generate decoded reverberation parameters;
obtain reverberator parameters from the decoded reverberation parameters;
initialize at least one reverberator based on the reverberator parameters;
obtain at least one input audio signal associated with the at least one acoustic environment; and
generate an output audio signal based on the application of the at least one reverberator to the at least one input audio signal.

10. The apparatus as claimed in claim 9, wherein the bitstream further comprises at least one indicator indicating that the bitstream comprises at least one of: the encoded at least one frequency band data or the encoded at least one reverberation parameter, wherein the instructions, when executed with the at least one processor, cause the apparatus to determine the reverberation parameter part based on the at least one indicator.

11. The apparatus as claimed in claim 9, wherein the instructions, when executed with the at least one processor, cause the apparatus to determine the reverberation parameter part based on an indicator and the instructions further cause the apparatus to:
determine the bitstream comprises the at least one reverberation parameter in a high bitrate mode; and
determine the bitstream comprises the at least one frequency band data in a low bitrate mode.

12. The apparatus as claimed in claim 9, wherein the instructions, when executed with the at least one processor, cause the apparatus to determine the reverberation parameter part comprises an indicator indicating that the reverberator parameters are to be determined from at least one reverberation parameter encoded into a scene payload.

13. The apparatus as claimed in claim 9, wherein the instructions, when executed with the at least one processor, cause the apparatus to initialize the at least one reverberator using the at least one reverberator parameter independent on whether at least one acoustic environment is a virtual acoustic environment or an augmented reality acoustic environment.

14. A method for an apparatus for assisting spatial rendering in at least one acoustic environment, the method comprising:
obtaining at least one reverberation parameter;
converting the obtained at least one reverberation parameter into at least one frequency band data;
encoding the at least one frequency band data;
encoding the at least one reverberation parameter;
comparing resources required to transmit the encoded at least one frequency band data and the encoded at least one reverberation parameter; and
generating a bitstream comprising: an identifier identifying the at least one acoustic environment; information defining at least one dimension of the at least one acoustic environment; and a reverberation parameter part comprising a selection, based on the comparison, of one or more of: the encoded at least one frequency band data; or the encoded at least one reverberation parameter.

15. The method as claimed in claim 14, wherein generating the bitstream comprises a selection indicator configured to indicate the selection, based on the comparison, of one or more of:
the encoded at least one frequency band data; or
the encoded at least one reverberation parameter within the bitstream.

16. The method as claimed in claim 14, further comprising obtaining a scene description defining a virtual scene forming at least part of the at least one acoustic environment, wherein the at least one reverberation parameter is associated with the virtual scene.

17. The method as claimed in claim 14, wherein the reverberation parameter part comprising the selection based on the comparison comprises:
selecting the encoded at least one reverberation parameter in a high bitrate mode; and
selecting the encoded at least one frequency band data in a low bitrate mode.

18. A method for an apparatus for assisting spatial rendering in at least one acoustic environment, the method comprising:
obtaining a bitstream, the bitstream comprising: an identifier identifying the at least one acoustic environment; information defining at least one dimension of the at least one acoustic environment; and a reverberation parameter part comprising one of: an encoded at least one frequency band data or an encoded at least one reverberation parameter;
decoding the reverberation parameter part to generate decoded reverberation parameters;
obtaining reverberator parameters from the decoded reverberation parameters;
initializing at least one reverberator based on the reverberator parameters;
obtaining at least one input audio signal associated with the at least one acoustic environment; and
generating an output audio signal based on the application of the at least one reverberator to the at least one input audio signal.

19. The method as claimed in claim 18, wherein the bitstream further comprises at least one indicator indicating that the bitstream comprises at least one of:
the encoded at least one frequency band data; or
the encoded at least one reverberation parameter, wherein obtaining reverberator parameters from the decoded reverberation parameters comprises determining the reverberation parameter part based on the at least one indicator.

20. The method as claimed in claim 18, wherein obtaining reverberator parameters from the decoded reverberation parameters comprising determining the reverberation parameter part based on at least one indicator comprises at least one of:
determining the bitstream comprising the at least one reverberation parameter in a high bitrate mode;
determining the bitstream comprising the at least one frequency band data in a low bitrate mode; or
indicating that the reverberator parameters are to be determined from at least one reverberation parameter encoded into a scene payload.

21. (canceled)

22. The method as claimed in claim 18, wherein initializing at least one reverberator based on the reverberator parameters comprises initializing the at least one reverberator using the at least one reverberator parameter independent on whether at least one acoustic environment is a virtual acoustic environment or an augmented reality acoustic environment.

23-24. (canceled)
